(19) United States
(12) Patent Application Publication
(10) Pub. No.: US 2019/0290049 A1
(43) Pub. Date: Sep. 26, 2019

(54) Capsule System For Producing A Beverage

(71) Applicant: BSH HAUSGERAETE GMBH, MUENCHEN (DE)

(72) Inventors: ALEXANDER JANTSCHKE, HAAR (DE); PHILIPP KLEINLEIN, MUENCHEN (DE); EVGENI REHFUSS, MUENCHEN (DE); LEO SOMMER, MUENCHEN (DE)

(21) Appl. No.: 16/307,219

(22) PCT Filed: Jun. 1, 2017
(86) PCT No.: PCT/EP2017/063313

§ 371 Date: Dec. 5, 2018

(30) Foreign Application Priority Data
Jun. 7, 2016 (DE) 10 2016 210 033.5

(51) Int. Cl. A47J 31/36; A47J 31/52; B65D 85/804; A47J 31/40

(52) U.S. Cl. CPC A47J 31/3633; A47J 31/407; B65D 85/8043; A47J 31/5251

(57) ABSTRACT

A capsule system for producing a beverage has a housing that defines an inner region of the capsule system. A receiving unit receives a capsule for producing a beverage. A conveyor conveys a capsule received by the receiving unit to a processing position. The conveyor has a conveying carriage which is moved by one or more actuators from an extended state into a retracted state. The receiving unit is arranged on the conveying carriage such that, in the extended state, it is located outside the housing for receiving a capsule and, in the retracted state, it is located at the processing position. A control unit causes the conveying carriage to move from the extended state into the retracted state, in order to convey the first capsule to the processing position, and to cause a beverage to be produced from the contents of the first capsule.

The invention relates to a system for producing an individually portioned beverage on the basis of a capsule containing ingredients for such a beverage.

A wide variety of capsule-based beverage systems are used in both professional and consumer applications. Hot beverages such as coffee or tea and cold beverages such as lemonades, etc. can be produced on the basis of the contents of capsules. For this purpose, a capsule usually contains ingredients (e.g. a syrup, a powder, etc.) which need to be dissolved in a liquid (in particular in water) that is to be added separately in order to produce the beverage selected in each case. The capsule-based beverage systems (referred to in this document as capsule systems) prepare the respective beverage one portion at a time and as needed with the aid of the ingredients contained in a capsule.

To produce a beverage, a user typically inserts a capsule into the capsule system and thereupon initiates a process in which the ingredients contained in the capsule are mixed with liquid in order to produce the beverage. In this process, a capsule may sometimes be inserted incorrectly or become jammed, which can lead to problems when producing a beverage. Different aspects of systems for producing a beverage are described in WO 2012/123 440 A1, DE 600 21 531 T1, U.S. Pat. No. 9,155,418 B2, DE 601 26 287 T2, EP 0 199 953 B1, DE 603 09 723 T2, US 2008/0 203 870 A1, DE 10 2008 014 233 B4, DE 10 2007 041 093 A1.

The present document is concerned with the technical problem of providing a capsule system for producing a beverage which enables a capsule to be inserted and processed in a reliable manner and consequently facilitates the reliable production of a beverage.

The problem is solved by means of the subject matter of the independent claim. Advantageous embodiment variants are defined in particular in the dependent claims, described in the following description or illustrated in the figures of the attached drawing.

According to one aspect of the invention, a capsule system for producing a beverage is described. In the process, in particular a capsule comprising ingredients for a single portion (e.g. for one glass) of an (alcoholic or non-alcoholic) beverage can be processed by the capsule system. A portion of a beverage composed of the ingredients of a capsule (in particular of substantially all of said ingredients) can be produced by the capsule system.

The capsule system comprises a housing which at least partially surrounds an inner region of the capsule system. The housing may for example be in the shape of a cube, with four side walls, a base and a top wall. The capsule system may be embodied for example as a domestic appliance, in particular as a household appliance which can be placed e.g. onto a countertop in a kitchen and/or installed in a built-in cabinet.

The capsule system also comprises a receiving unit which is configured to accommodate a capsule for producing a beverage. In particular, the receiving unit is able to allow a user to transfer a capsule to the capsule system. At the receiving unit, the capsule is then accepted by the capsule system and typically is subsequently no longer touched by a user. In certain cases the receiving unit may comprise means (e.g. a recess for a finger) which enable a user to remove a capsule that has already been transferred to the capsule system again (e.g. if it has been realized that a capsule has been inserted for the wrong type of beverage).

The capsule system further comprises conveying means which are configured to convey a capsule accepted by the receiving unit to a processing position in the inner region of the capsule system by means of one or more actuators. The one or more actuators can be driven e.g. electrically. In particular, the one or more actuators may comprise one or more electric motors. A reliable and precise arrangement of a capsule at a specific processing position in the inner region of the capsule system can be ensured through the use of automatic conveying means.

The capsule can be opened at the processing position in order to produce a beverage from ingredients contained in the capsule. For this purpose, the capsule system may in particular comprise processing means which are configured to open a capsule arranged at the processing position in order to produce a beverage from the ingredients contained in the capsule. The processing means may comprise e.g. one or more (hollow) needles by means of which the lid of a capsule can be opened in order to provide access to the ingredients contained in the capsule. If necessary, a liquid can then be flushed through the opened capsule in order to produce a beverage from the ingredients contained therein. The capsule system may additionally comprise a dispensing unit for providing a beverage produced from a capsule.

The capsule system also comprises a control unit which is configured to control the process for producing a beverage. In particular, the control unit is configured to cause the conveying means to convey a first capsule received by the receiving unit to the processing position. The control unit may furthermore be configured to cause a first beverage to be produced from the ingredients contained in the first capsule. In particular, the control unit may be configured to cause the processing means to produce a first beverage from ingredients contained in the first capsule and to provide said first beverage via the dispensing unit. In the process the first beverage can be produced automatically (i.e. without further action on the part of a user) as soon as the first capsule is located at the processing position in the inner region of the capsule system.

The capsule system enables a beverage to be produced in a convenient and reliable manner on the basis of the ingredients contained in a capsule. What is achieved in the process in particular through the use of driven conveying means is that a capsule is reliably and precisely conveyed to a specific processing position in the capsule system, thus enabling problems in the production process (such as e.g. incorrect placement of a capsule) to be avoided. The use of driven conveying means is advantageous in particular when using multichamber capsules (comprising a plurality of chambers for different substances for producing a beverage), since the opening and flushing of multichamber capsules of said type typically requires a particularly precise positioning of the capsule at a specific processing position.

The capsule system can therefore be configured to produce a beverage on the basis of a multichamber capsule comprising a plurality of chambers containing different substances for producing a beverage, thereby enabling complex beverages to be produced in a reliable manner.

The multichamber capsule may comprise an outer shell that has an outer base, an outer side wall and an outer lid which form an overall cavity of the multichamber capsule. The multichamber capsule may additionally comprise at least one inner shell which is arranged inside the overall cavity of the capsule and which forms a second chamber for receiving a second volume of a second ingredient. In this case a remaining cavity of the multichamber capsule is formed by the overall cavity minus the at least one inner shell as a first chamber for receiving a first volume of a first ingredient. The processing means may be configured to open the inner shell of the capsule and to create a cavity within the capsule for receiving a mixture which fully comprises the first ingredient and the second ingredient. Complex beverages can be produced in a reliable manner by producing an ingredient mixture within a multichamber capsule.

The processing means may be configured to tilt the capsule in order to pour the ingredients contained therein, in particular the ingredient mixture, out of the capsule through an opening in the outer lid. Efficient production of a beverage is made possible in this way.

The receiving unit can have a shape that is matched to a shape of the capsule, thus enabling a capsule to be transferred in a reliable manner. In particular, a recess of the receiving unit for accommodating a capsule can have a contour that corresponds to a contour or outline of the capsule. In this case a capsule may be e.g. cylinder-shaped, with base and lid surfaces of different sizes. The receiving unit may comprise an opening or recess that is matched to the different sizes of the base and lid surfaces of the capsule. In this way it is possible to influence a user to transfer a capsule to the capsule system with a correct orientation in an intuitive manner.

The receiving unit may be arranged e.g. on a front wall of the housing. Positioning the unit on the front wall enables a user to transfer a capsule to the capsule system at a relatively low height. For example, the capsule system may be arranged as a household appliance on a countertop in a kitchen, such that a receiving unit arranged on the front wall of the capsule system allows a convenient, ergonomically optimal capsule transfer.

Alternatively or in addition, the receiving unit may be embodied in such a way that a capsule having an upward-oriented lid can be introduced into the receiving unit. In this case the lid of the capsule can have a greater surface area than the base of the capsule and the receiving unit can have a corresponding shape. The capsule lid typically serves to indicate which type of beverage may be produced with the capsule (e.g. by means of a particular color and/or by means of an imprinted logo or legend). Transferring a capsule with the lid facing upward therefore enables the inserting of wrong capsules to be avoided.

Alternatively or in addition, the receiving unit may be embodied in such a way that the capsule can (where applicable, also) be inserted into the receiving unit (in particular into a capsule receptacle) in an upside-down position, that is to say with the capsule top oriented downward. Alternatively or in addition, the receiving unit may be embodied in such a way that the capsule can (where applicable, also) be inserted into the receiving unit (in particular into a capsule receptacle) in a horizontal position (rotated through 90°), with the top facing toward the system or the housing. Alternatively or in addition, the receiving unit may be embodied in such a way that the capsule can (where applicable, also) be inserted into the receiving unit (in particular into a capsule receptacle) in a horizontal position (rotated through 90°), with the top facing toward the user or, as the case may be, away from the system/housing.

The conveying means preferably comprise a conveying carriage which can be conducted by means of the one or more actuators from an extended state into a retracted state. In particular, the conveying carriage may be disposed in the extended state for the purpose of receiving a capsule in order to enable a user to transfer the capsule in a convenient manner. In this case the receiving unit may be arranged on the conveying carriage such that in the extended state the receiving unit is located outside the housing of the capsule system and consequently allows a convenient handover of the capsule. On the other hand, the receiving unit may be disposed in the retracted state at the processing position in order to produce a beverage from the ingredients contained in a capsule. The conveying carriage may for example have a recess into which a capsule can be inserted (when the conveying carriage is disposed in the extended state). For this purpose, the recess may have a shape corresponding to a capsule. The receiving unit may therefore comprise a recess in the conveying carriage or correspond to such a recess. The control unit may be configured to cause the conveying carriage to move into the extended state in order to enable a user to transfer the first capsule to the receiving unit. The movement of the conveying carriage into the extended state may be triggered in response to an input by a user via a user interface of the capsule system. Furthermore, the control unit may be configured to cause the conveying carriage to move into the retracted state in order to convey the first capsule to the processing position. The use of a conveying means enables a capsule to be transferred in a particularly convenient and reliable manner from an outer region of the capsule system to the processing position in the inner region of the capsule system.

The conveying carriage may have an illumination region that has a plurality of illumination states. The illumination states may be different from one another e.g. in respect of color, light intensity and/or variations in color and/or intensity over time. The control unit may be configured to activate the illumination region in order to output information relating to the production of the first beverage by means of the plurality of illumination states. In this case the information relating to the production of the first beverage may in particular comprise: a process status during the production of the first beverage and/or a type of the first beverage produced. The interaction of the capsule system with a user can be improved as a result of the provision of an illumination region of said type.

Alternatively or in addition, the conveying carriage may have an interchangeable front section. In this case the front section may be designed to enable a user input (e.g. by providing an input button). In particular, the front section may be designed to enable a user to trigger the retraction of the conveying carriage by touching the front section and where applicable directly initiate the production of a beverage. Providing a front section therefore promotes an improved user interaction.

The capsule system may comprise a pressure sensor which is configured to detect an external force acting on the conveying carriage in the extended state, which external force acts in the direction of the retracted state of the conveying carriage. For example, it can be detected that a user is applying pressure on the conveying carriage with a certain external force. The control unit may be configured to cause the conveying carriage to be conducted into the retracted state in response to the detection of the external force. An intuitive activation of the conveying means can be provided in this way.

The capsule system may comprise a protective bracket which is embodied to enclose the conveying carriage in the extended state. In this way the capsule system and in particular the conveying carriage can be reliably protected against external influences.

Alternatively or in addition, the conveying means may comprise one or more conveying belts, conveying rolls and/or conveying rollers which are driven by means of the one or more actuators. In this case the conveying means may be designed to touch a capsule and to convey the capsule to the processing position by means of a movement of the one or more conveying belts, conveying rolls and/or conveying rollers. A reliable conveying of a capsule into the inner region of the capsule system can be ensured in this way.

Alternatively or in addition, the conveying means may comprise a rotatably mounted cylinder (in particular a circular cylinder) which can be rotated by means of the one or more actuators about a vertical axis of the cylinder so that a base area of the cylinder is arranged partially in the inner region and partially outside the housing at all times. The rotatably mounted cylinder is also referred to in this document as a revolving magazine. In this arrangement, the vertical axis of the cylinder may extend substantially perpendicularly between the base and the top wall of the housing of the capsule system. Furthermore, the vertical axis may extend along the front wall of the housing of the capsule system.

The receiving unit may be formed by a first recess on the base area of the cylinder which is arranged in such a way that the first recess can be moved by a rotation of the cylinder from a first state outside the housing into a second state at the processing position. For this purpose, the first recess may be arranged at a certain distance from the vertical axis. In particular, the first recess may be located closer to an edge of the base area of the cylinder than to the vertical axis of the cylinder. The control unit may be configured to cause the one or more actuators to rotate the cylinder about the vertical axis in order to convey the first capsule received by the receiving unit to the processing position. The use of a rotatably mounted cylinder enables a capsule to be transferred in a convenient and precise manner into the inner region of the capsule system.

The capsule system may have a circumferential impact protection bumper which at least partially surrounds a lateral surface area of the cylinder outside the housing. In this way, the capsule system can be protected from the effects of external forces.

The cylinder may have a second recess on the base area of the cylinder, which second recess is embodied for receiving a further capsule. The first recess may be arranged at a first position on the base area and the second recess at a position on the base area such that the first position and the second position can be connected to one another by means of a straight line which intersects the vertical axis of the cylinder (and typically extends perpendicularly to the vertical axis). The first position and the second position may in this case be arranged on the straight line on different sides of the vertical axis. In particular, the first and the second recess may be arranged on the base area in such a way that in the first state the first recess is located outside the housing and the second recess is located at the processing position, and in the second state the second recess is located outside the housing and the first recess is located at the processing position. By providing a plurality of recesses as receiving units it is possible to speed up the sequential production of a plurality of beverages.

The capsule system may comprise a sensor which is configured to detect that the first capsule is transferred to the capsule system by way of the receiving unit. In response thereto, the control unit may be configured to cause the conveying means to convey the first capsule to the processing position. In particular, it is possible, without a dedicated input on the part of a user, to cause the first capsule, after being transferred to the receiving unit, to be conveyed into the inner region. Furthermore, the production of the first beverage may be initiated automatically where applicable (i.e. without any further input by a user). Thus, the production of a beverage can be initiated in a particularly convenient manner (in particular without an explicit input by a user of the capsule system, where applicable solely in response to a capsule being transferred to the capsule system on the receiving unit).

The capsule system may comprise a read sensor which is configured to capture information relating to a capsule received by the receiving unit. The read sensor may comprise e.g. an RFID reader, an NFC reader and/or a reader for a machine-readable code (e.g. a QR code). The capsule may comprise a corresponding data medium (e.g. an RFID chip, an NFC chip and/or a machine-readable code). The control unit may be configured to produce the first beverage as a function of the captured information relating to the first capsule. In particular, the control unit may determine, on the basis of the captured information, the amount of one or more additional ingredients (e.g. water) and/or one or more process steps needed for producing the first beverage. As a result, the capsule system would be capable of producing different types of beverages in a convenient and reliable manner.

The capsule system may comprise a user interface by means of which a user can e.g. cause the conveying means to convey a capsule to the processing position. Alternatively or in addition, a user may specify one or more parameters of a beverage that is to be produced via the user interface.

The capsule system may further comprise (where applicable, electrically) driven means which, after the ingredients have been extracted from a capsule, convey the capsule away from the processing position in order to free up the processing position for receiving a following capsule. In particular, an emptied capsule may be conveyed into a collecting container of the capsule system that is provided for that purpose.

It is important to note that any aspects of the system described in this document may be combined with one another in a variety of ways. In particular, the features of the claims may be combined with one another in a variety of ways.

The invention is described in more detail hereinbelow with reference to exemplary embodiments illustrated in the figures of the attached drawing, in which:

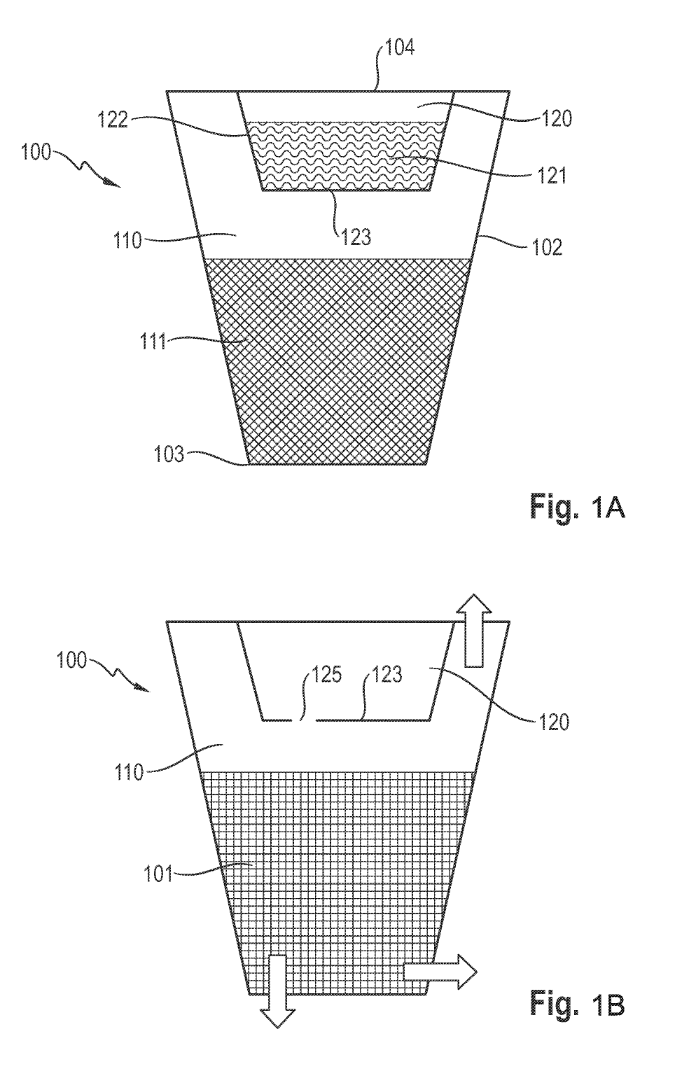

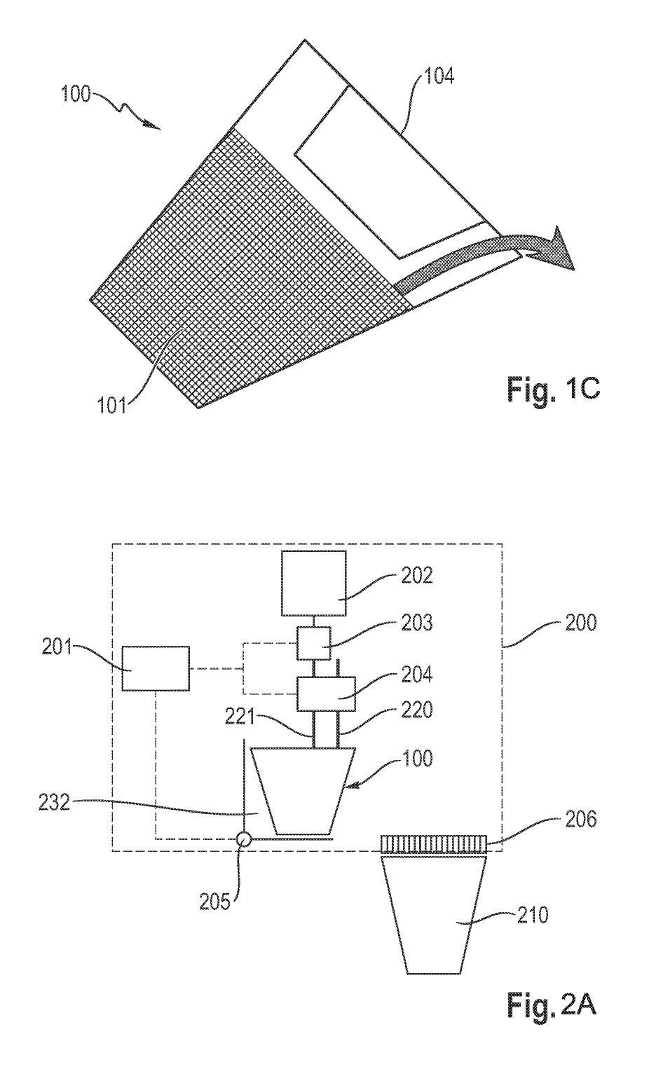

FIG. 1a shows an exemplary multichamber capsule in the sealed state;

FIG. 1b shows an exemplary multichamber capsule in the opened state;

FIG. 1c shows the exemplary emptying of a multichamber capsule;

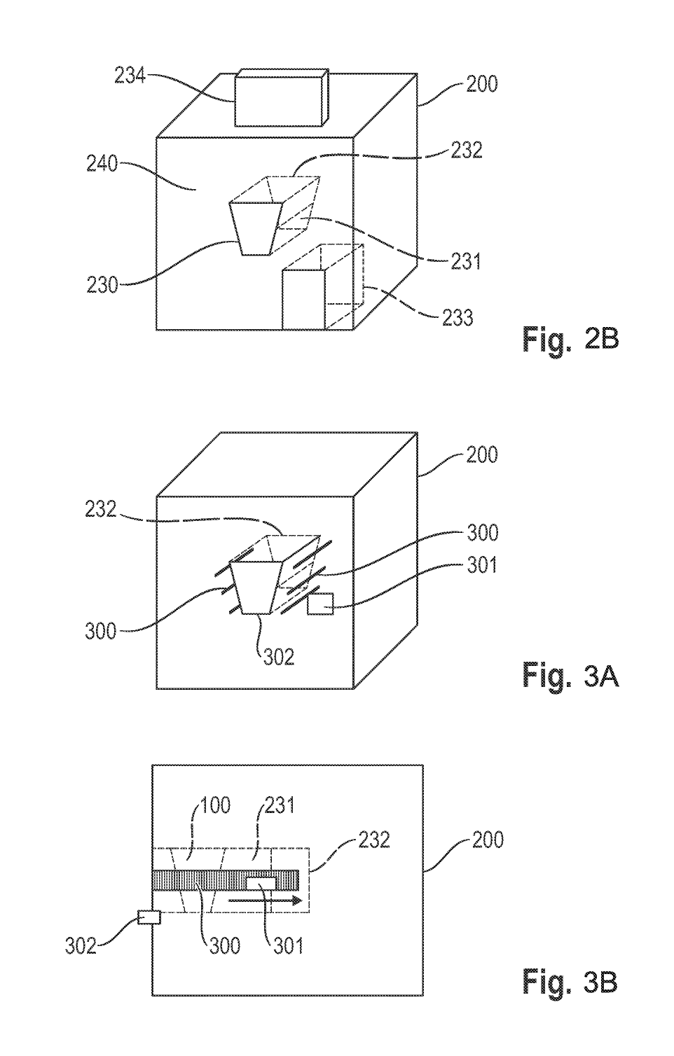

FIG. 2a shows a block diagram of an exemplary capsule system for producing a beverage;

FIG. 2b shows a perspective view of a capsule system for producing a beverage;

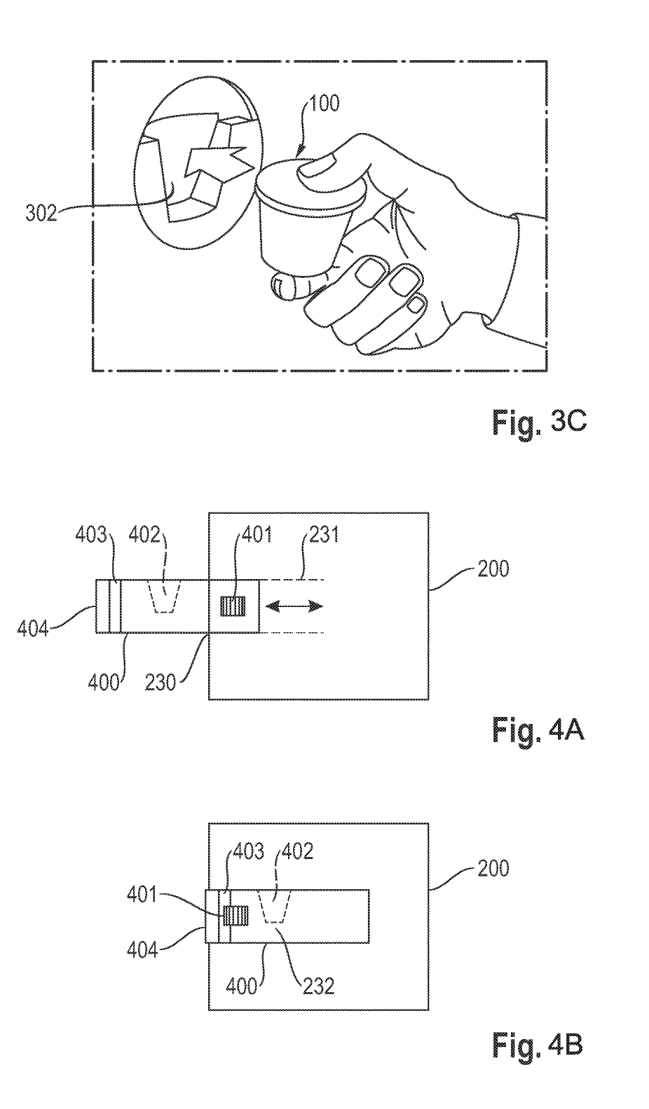

FIG. 3a shows a perspective view of exemplary conveying belts for conveying a capsule to a processing position;

FIG. 3b shows a side view of an exemplary conveying belt for conveying a capsule to a processing position;

FIG. 3c shows an exemplary receiving unit for receiving a capsule;

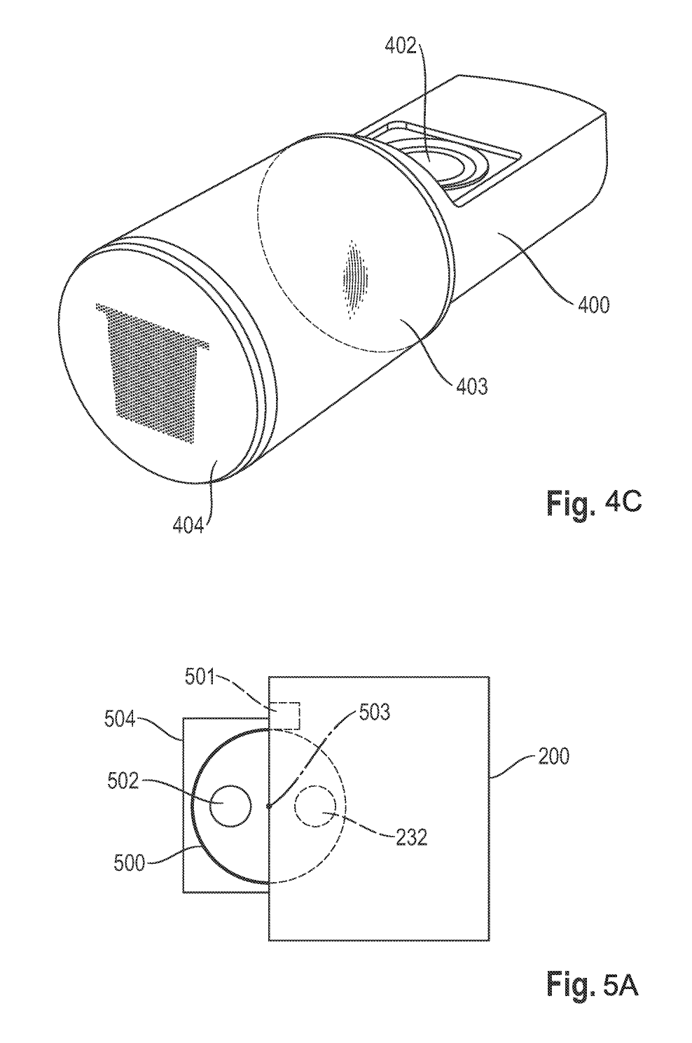

FIG. 4a shows a side view of an exemplary conveying carriage for a capsule in the extended state;

FIG. 4b shows a side view of an exemplary conveying carriage for a capsule in the retracted state;

FIG. 4c shows a perspective view of an exemplary conveying carriage;

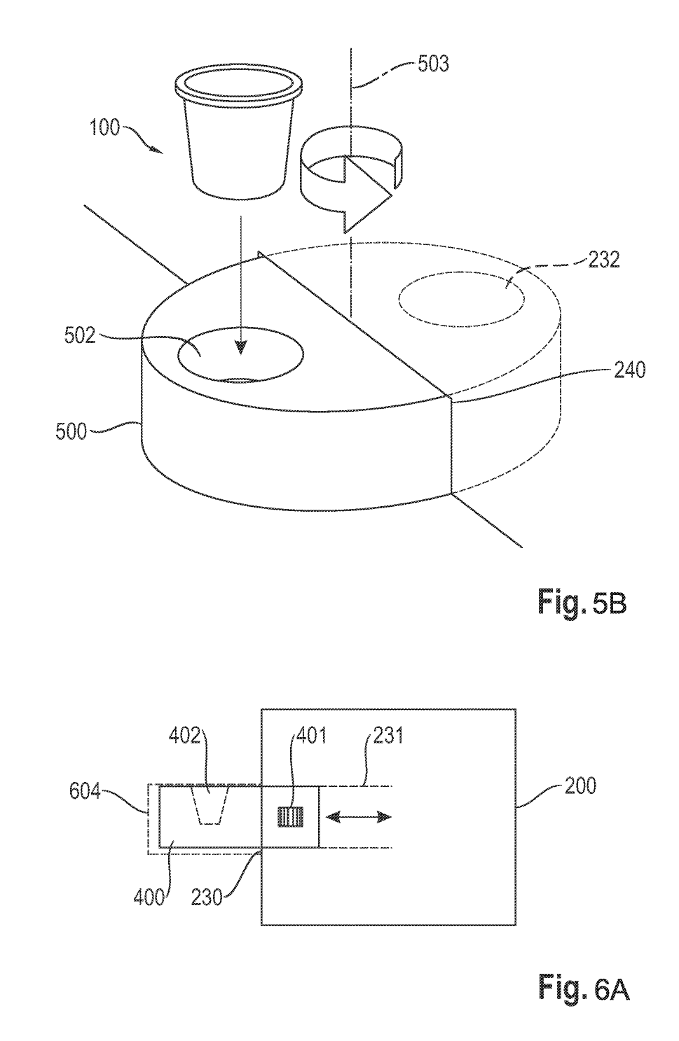

FIG. 5a shows a plan view of an exemplary revolving magazine for receiving and conveying a capsule;

FIG. 5b shows a perspective view of an exemplary revolving magazine;

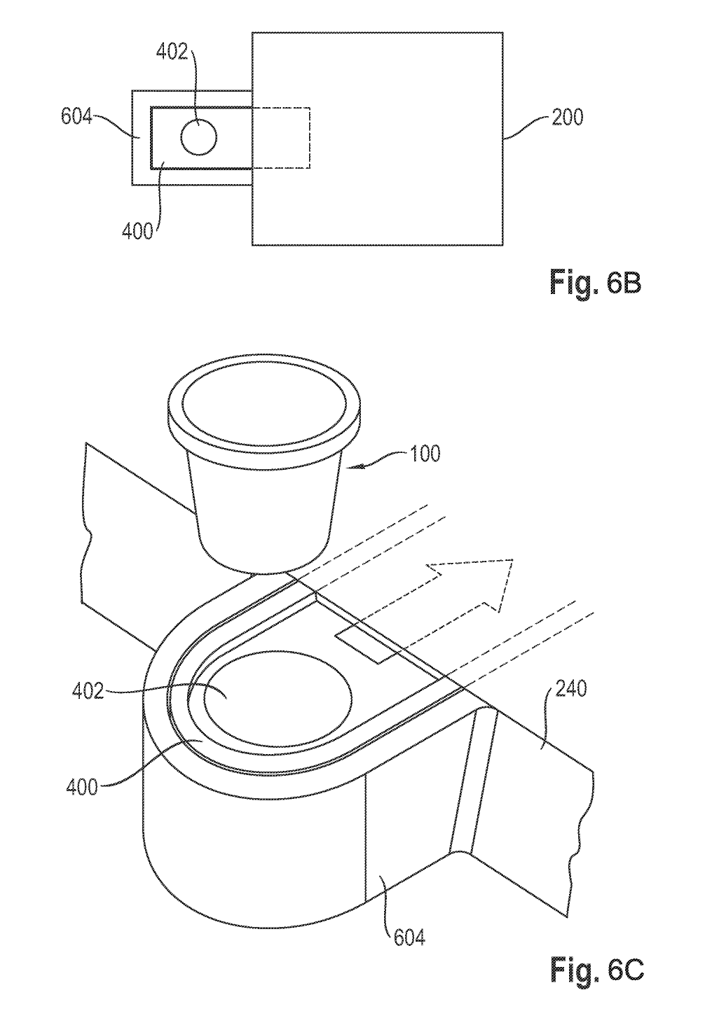

FIG. 6a shows a side view of an exemplary conveying carriage with protective frame;

FIG. 6b shows a plan view of an exemplary conveying carriage with protective frame; and

FIG. 6c shows a perspective view of an exemplary conveying carriage with protective frame.

As stated in the introduction, the present document relates to the reliable production of a beverage on the basis of the ingredients contained in a capsule.

In this connection, FIG. 1a shows an exemplary capsule, in particular an exemplary multichamber capsule 100. The capsule 100 depicted in FIG. 1a comprises two chambers 110, 120, the chambers 110, 120 being formed by separate shells, one nested inside the other. An outer shell is formed by an outer side wall 102 and an outer base 103 which enclose an overall cavity of the capsule 100. In the overall cavity there is arranged an inner shell which is formed by an inner side wall 122 and an inner base 123. In the example shown, the inner shell and the outer shell are sealed by means of a common lid 104.

The inner shell forms the second chamber 120 for receiving a second ingredient 121. Where applicable, a plurality of inner shells forming a plurality of separate chambers 120 for receiving different ingredients or substances may be arranged within the outer shell, i.e. inside the overall cavity of the capsule 100. The overall cavity minus the one or more inner shells forms a remaining cavity which forms the first chamber 110 for receiving a first ingredient 111. The ingredients 111, 121 (which are also referred to as substances in this document) may be liquid and/or solid (e.g. in powder form) or comprise liquid and/or solid (e.g. in powder form) constituents. Each chamber 110, 120 of the capsule 100 may comprise a certain volume of an ingredient. Said volumes of different ingredients are used substantially in their entirety for producing a beverage. Furthermore, the chambers 110, 120 may comprise gases (e.g. air or inert gas), where applicable, which are not used for the production process.

The multichamber capsule 100 may be embodied in such a way that, as part of the process of producing a beverage, a cavity may be created within the multichamber capsule 100 for receiving an ingredient mixture 101 which comprises the first ingredient 111 and the second ingredient 121 (substantially in their entirety). In other words, the multichamber capsule 100 may be embodied in such a way that there may be produced within the multichamber capsule 100 (e.g. inside the first chamber 110) an ingredient mixture 101 which comprises all of the ingredients 111, 121 of the capsule 100 that are intended for the beverage (e.g. in the form of a solution and/or an emulsion). A reliably reproducible production of a beverage from multichamber capsules 100 may be realized in this way.

FIG. 1a shows a multichamber capsule 100 in the sealed state. The capsule system may comprise means (e.g. one or more needles) for opening one or more chambers 110, 120 of a capsule 100 and for mixing the ingredients 111, 121 of the chambers 110, 120 with one another. For example, as shown in FIG. 1b, an opening 125 in the inner base 123 of the inner shell can be produced so that the second ingredient 121 can pass (in its entirety) from the second chamber 120 into the first chamber 110 and mix inside the first chamber 110 with the first ingredient 111 in order to produce an ingredient mixture 101. The ingredient mixture 101 can then be extracted via one or more further openings (e.g. in the outer lid 104, in the outer base 103 and/or in the outer side wall 102) from the capsule 100 (as indicated by the arrows). For example, the capsule 100 can be tilted (as shown in FIG. 1c) in order to pour the ingredient mixture 101 out of the capsule 100 through an opening in the outer lid 104 due to the effect of the force of gravity.

The capsule system may therefore comprise e.g. a needle for puncturing a capsule 100 as well as means for mixing and/or dissolving the substances 111, 121 (where applicable, using one or more liquids such as e.g. water or alcohol or using steam). The capsule system may additionally comprise means to empty the ingredient mixture 101 created in the process and where applicable to mix it with a further liquid or transfer it directly into a glass in order to provide a beverage. FIGS. 1a to 1c show a two-chamber capsule by way of example. However, more than two chambers 110, 120 or where applicable only one chamber may be provided within the overall cavity of a capsule 100.

As shown in FIG. 1b, the one or more (inner) shells or chambers 120 can be opened in order to mix together the substances 111, 121 contained in a capsule 100. Only the substances 111, 121 contained in the chambers 110, 120 can be mixed together in this case. Alternatively, one or more further media (e.g. in liquid and/or gaseous form) can be fed into the capsule 100 from outside in order to mix together the substances 111, 121 contained in the chambers 110, 120. The mixture 101 produced in the capsule 100 can therefore also comprise one or more further media (in particular flushing media) in addition to the ingredients 111, 121. In this case the capsule 100 is preferably designed in such a way that said media can also be accommodated. In order to produce the mixture 101, at least one chamber 120 can be emptied completely and if necessary flushed through by means of a flushing medium. The mixture 101 (e.g. a solution and/or emulsion) produced in this way can then be supplied to the further beverage preparation process (outside the capsule 100) using a variety of implementation ways and means.

FIG. 2a shows a block diagram of an exemplary capsule system 200. The capsule system 200 comprises a control unit 201 which is configured to control the production process. A capsule 100 can be transferred to the system 200 (into a capsule receiving unit of the system 200 provided for that purpose) by a user. The capsule can then be conducted via conveying means to a processing position 232 in the interior of a housing of the capsule system 200. The conveying means can be activated by the user (e.g. by actuating a pushbutton or directly by inserting the capsule 100). When the capsule 100 arrives at the processing position 232, the production process can then be initiated.

Within the scope of the production process, the control unit 201 causes the means 221, 220 for opening the capsule 100 (e.g. (hollow) needles) to be guided to the capsule 100. For this purpose, an actuator 204 can be energized so as to introduce e.g. the needles 221, 220 into the capsule 100. In addition, a further actuator 203 can be energized in order to force a flushing medium under pressure (e.g. out of a container 202 of the system 200) into the capsule 100 in order to flush out at least one chamber 120 in the capsule 100. In this way, in a first step where applicable, a mixture 101 of the ingredients 111, 121 can be produced from different chambers 110, 120 of a capsule 100. The mixture 101 can then be extracted from the capsule 100. The system 200 may for example have a tilt mechanism 205 which is configured to tilt the capsule 100 so that the mixture 101 can be poured from the capsule 100 (e.g. through the opening 105 in the outer lid 104). In particular, the mixture 101 can be poured via a dispensing unit 206 of the system 200 into a beaker 210 in which the beverage that is to be prepared is provided to the user. The system 200 may also be configured to fill the beaker 210 with further one or more liquids for the beverage that is to be prepared.

FIG. 2b shows a perspective view of parts of the capsule system 200. The capsule system 200 typically comprises a housing having a plurality of housing walls which at least partially enclose an inner region of the capsule system 200. On one wall 240 (in particular on a front wall) of the capsule system 200 there may be arranged an opening 230 from which a capsule 100 can be conveyed via a conveying path 231 to the processing position 232 in the inner region of the housing. At the processing position 232, the capsule 100 can be opened and emptied in order to produce a beverage. The beverage can then be dispensed in a dispensing region 233 via a dispensing unit 206. FIG. 2b further shows a user interface 234 (e.g. having a touch-sensitive screen) via which a user can effect a setting of the capsule system 200. As shown in FIG. 2b, the user interface 234 can be arranged on an upper housing wall of the capsule system 200. The capsule system 200 may be embodied as a domestic appliance, in particular as a household appliance which can be placed e.g. onto the countertop in a kitchen.

In the following there are described exemplary conveying means with the aid of which a capsule 100 is automatically conveyed from a receiving unit (which is arranged e.g. on or in front of the front wall 240) to the processing position 232. For this purpose, the conveying means comprise one or more actuators by means of which a movement of a capsule 100 to the processing position 232 can be effected. As a result of conveying a capsule 100 automatically to a defined processing position 232 with the aid of driven conveying means, misplacements of capsules 100 and/or situations where capsules 100 become jammed can be avoided, thereby enabling beverages to be produced in a reliable manner.

FIG. 3a shows, as an example of a conveying means, a conveying belt 300 which is moved by one or more actuators (e.g. electric motors) 301 and which is configured to convey a capsule 100 from a receiving unit 302 at the opening 230 of the housing wall 240 to the processing position 232 in the inner region of the housing. The conveying belt 300 can be moved e.g. by means of electrically driven rollers. FIG. 3b shows the conveying belt 300 in a side view. It is illustrated in particular in FIG. 3b how a capsule 100 may be transferred by a user at the receiving unit 302 to the capsule system 100 and is then conveyed automatically by the conveying belt 300 into the inner region of the system 200 to the processing position 232.

FIG. 3c illustrates how a user may transfer a capsule 100 at the receiving unit 302 to the system 200. In this case there may be arranged at the receiving unit 302 one or more sensors which detect that a capsule 100 is being transferred to the system 200. In response thereto, the conveying means 300 (i.e. in particular the conveying belt) can be activated in order to convey the capsule 100 into the interior of the system 100. Furthermore, the process of producing a beverage can be initiated automatically when the capsule 100 arrives at the processing position 232.

An input slot 302 (i.e. a receiving unit) may therefore be located at the front of the beverage system 200 (e.g. similar to the input slot on an automated teller machine). The contour of a recess of the receiving unit 302 may in this case correspond to the contour of a capsule 100, thus enabling a defined transfer of a capsule 100 to the system 200. One, two or more guide rails may be used to lock a capsule 100 in position. A capsule 100 can be pushed into the recess of the receiving unit 302 and can be received there by conveying means 300 (e.g. by driven rollers or by a driven belt transport system) and drawn further into the interior of the system 200. The overall appearance of the system 200, achieved by virtue of the styling of the receiving unit 302, enables the capsule insertion process to be realized in a self-explanatory and ergonomic manner, as a result of which operating errors can be excluded or at least reduced. Furthermore, a receiving unit 302 of said type enables the number of interaction steps to be reduced since the insertion of a capsule automatically causes the production of a beverage to be initiated. Moreover, the system 200 exhibits a high degree of robustness because the conveying means 300 are arranged entirely in the interior of the system 200 and consequently cannot be touched and possibly damaged by a user.

FIG. 4a shows a conveying carriage 400 as exemplary conveying means in a side view. The conveying carriage 400 comprises a receiving unit 402 in the form of a recess into which a capsule 100 can be inserted by a user (similarly to loading a CD into a CD drive in the eject state). The conveying carriage 400 can be driven, e.g. in response to an input by a user, by means of an actuator 401 (e.g. by means of an electrically driven gear wheel) into the interior of the system 200 in order to convey the capsule 100 to the processing position 232. FIG. 4b shows the conveying carriage 400 in a retracted state.

The front side of the conveying carriage 400 may comprise an illumination region 403 (such as illustrated, inter alia, in FIG. 4c) which can be illuminated in different colors where applicable. A status of the system 200 can be communicated e.g. to a user via the illumination region 403. Alternatively or in addition, information relating to the produced beverage can be displayed to the user (e.g. by means of a defined color coding scheme). The front side of the conveying carriage 400 may furthermore have a cover region 404 which may be used where applicable for sensing an input by a user (e.g. by means of a touch).

Similarly to a CD tray, the conveying carriage 400 can be ejected from the system 200 and makes available an insertion means (i.e. a receiving unit 402) for loading a beverage capsule 100. A user can place a capsule 100 into the receiving unit 402 and the conveying carriage 400, loaded with the capsule 100, can then be retracted into the system 200, whereupon the production process for preparing a beverage can be started.

With a closed conveying carriage 400, the system 200 is therefore sealed off from or protected against environmental/external influences. The conveying carriage 400 is opened and closed automatically or by motorized means by way of one or more actuators 401. Triggers for the retraction movement may be in particular the following elements or interactions:
the actuation of a dedicated input region (e.g. key, pushbutton, screen field, etc.) on the beverage system 200;
the front side of the conveying carriage 400, which serves as a dedicated input region (e.g. via a touch interaction or by means of a light pressure as in the case of a CD tray (without use of a sensor on the front side of the conveying carriage 400)); and/or
the actuation of an input via a user interface 234 of the system 200 (e.g. a (possibly virtual) pushbutton integrated therein).

The conveying carriage 400 may be implemented overall as electrically powered. In particular, a power supply can be provided on the conveying carriage 400 (e.g. for a read system for detecting a capsule type, for the illumination region 403 and/or for input means on the front side of the conveying carriage 400).

On the underside of the conveying carriage 400 (in particular on the underside of the receiving unit 402) there may be arranged a read system or a read sensor which is configured to detect a capsule 100 after the latter has been inserted into the system 200. Based on the detected capsule 100, the system 200 is able to determine preparation parameters for the beverage that is to be produced. The read system may be based e.g. on NFC technology.

By means of a correspondingly designed integrated lighting system in the illumination region 403, at least one subsection of the conveying carriage 400 may be lit up in the color of the beverage that is to be prepared as a visual identification confirmation. For example, a lemonade may be indicated e.g. by means of yellow lighting, and a lime juice by means of green lighting. Flexibility in the setting of the color coding scheme is possible in this case. Alternatively or in addition, the status of the production process may be indicated by means of light sequences, e.g. pulsating, static or flashing light. Optionally, a further light source may be provided in the system 200 in order e.g. to illuminate the beverage platform (or the dispensing region 233). The illumination of the dispensing region 233 may be adjusted in accordance with the status of the production process. The interaction with the system 200 can be improved in this way.

The use of a conveying carriage 400 enables the capsule insertion process to be realized in a self-explanatory and ergonomic manner by virtue of the styling, as a result of which operating errors can be excluded or at least reduced.

The receiving unit 402 may have a lowered, (at least partially) circumferential edge around an inserted capsule 100. This can facilitate the removal of the capsule 100 (e.g. in the event of a premature termination of the production process).

The production process can be triggered automatically by the action of retracting the conveying carriage 400. The number of interaction steps can be minimized in this way.

Provision of an interchangeable cover section 404 affords flexibility in the styling and appearance of the front of the conveying carriage 400. Different covers or tops may be attached, for example. Said covers may consist of a variety of materials and/or have a different surface finish.

FIG. 5a shows a revolving magazine 500 (or a cylinder) as exemplary conveying means in a view from above. The revolving magazine 500 comprises at least one receiving unit 502 which is arranged outside the system 200 in a specific position on the revolving magazine 500 so that a user can insert a capsule 100 into the receiving unit 502. The revolving magazine 500 can then be rotated (e.g. in response to an input by a user) about an axis of rotation 503 (also referred to as the vertical axis) in order to convey the receiving unit 502 containing the capsule 100 into the interior of the system 200 and in particular to the processing position 232. For this purpose, the revolving magazine 500 can be driven by means of an actuator 501 (in particular by means of an electric motor). The revolving magazine 502 may be protected by means of a circumferential impact protection guard 504 in order e.g. to prevent the revolving magazine 502 from jamming. FIG. 5b shows a perspective view of a revolving magazine 500 (without impact protection guard 504).

A capsule 100 can be placed intuitively and in an upright position into a revolving magazine 500 of said type, i.e. the capsule 100 can be inserted with the lid side (which may be labeled with an inscription identifying the beverage that is to be produced) facing upward, thereby providing an enhanced level of convenience for a user.

The revolving magazine 500 represents a kind of carousel which automatically rotates an inserted capsule 100 into the interior of the system 200. A read system may be located on the underside of the rotating receiving unit 502 (or of the case), which read system is able to identify a capsule 100 following its insertion in order to determine appropriate preparation parameters. The beverage preparation process is performed in the interior of the system 200.

The revolving magazine 500 can rotate backward into the insertion position in order to produce a further beverage (e.g. if only one receiving unit 502 is provided). Alternatively, the rotational movement by means of which a capsule is rotated into the interior of the system 200 may be used to bring out a further receiving unit 502, in which (without further steps) a next capsule may be accommodated. This enables a plurality of beverages to be produced by means of a plurality of capsules 100 in a convenient and timely manner.

The revolving magazine 500 may therefore comprise one or more insertion openings or receiving units 502 and the rotation of the revolving magazine 500 may, where applicable, be effected in both directions of rotation. Damage to the revolving magazine 500 may be avoided through provision of a circumferential impact protection guard 504 which forms a single surface with the revolving magazine 500. Furthermore, by providing a plurality of receiving units 502 it is possible, where applicable, for a plurality of capsules 100 to be accommodated at the same time by the system 200 (and then be processed sequentially). By virtue of the design, capsule insertion is realized in a self-explanatory and ergonomic manner, as a result of which operating errors can be excluded or at least reduced. The beverage production process can be triggered directly by means of the rotational movement of the revolving magazine 500, thereby enabling the number of interaction steps to be reduced.

FIG. 6a (side view), FIG. 6b (plan view) and FIG. 6c (perspective view) show a conveying carriage 400 having a circumferential protective bracket 604 by means of which damage to the conveying carriage 400 can be avoided. In particular, the conveying carriage 400 is arranged inside a fixed bracket 604 in FIGS. 6a, 6b and 6c. A capsule 100 can be inserted in an upright manner (i.e. with the lid side facing upward) into the receiving unit 402 of the carriage 400. The carriage 400 automatically draws the capsule 100 into the interior of the system 200. As soon as the beverage preparation process has been completed, the capsule 100 can be ejected into a collecting container in the interior of the system 200, thereby making the receiving unit 402 available once again. The carriage 400 can then be driven back (where applicable, automatically) into the extended insertion position and is therefore ready to receive the next capsule 100. By providing a protective bracket 604 it is made possible in this case for the carriage 400 to be extended as standard (even in the deactivated state). The level of convenience for a user can be increased as a result.

The carriage 400 may be driven e.g. by way of a worm gear, a pinion gear, a belt transmission, etc.

The fixed bracket 604 forms a kind of bumper which protects the system 200 (in particular the carriage 400) against impact shocks and other effects of force.

The present invention is not limited to the illustrated exemplary embodiments. In particular, it should be noted that the description and the figures are intended simply to clarify the principle of the proposed system.

1-13. (canceled)

14. A capsule system for producing a beverage, the capsule system comprising:
a housing at least partially surrounding an inner region of the capsule system;
a receiving unit configured to receive a capsule for producing a beverage;
a conveyor having a conveying carriage and one or more actuators, said conveyor being configured to convey a capsule received by said receiving unit to a processing position in the inner region of the capsule system; wherein said one or move actuators are configured to guide said conveying carriage from an extended state into a retracted state; wherein said receiving unit is arranged on said conveying carriage such that, in the extended state, said receiving unit is located outside the housing of the capsule system in order to receive a capsule and, in the retracted state, said receiving unit is located at the processing position;
a processing device configured to open a capsule at the processing position in order to produce a beverage from ingredients contained in the capsule;
a dispensing unit for providing a beverage produced from a capsule; and
a control unit which is configured:
to cause said conveying carriage to move from the extended state into the retracted state in order to convey a first capsule to the processing position; and
to directly thereafter cause said processing device to produce a first beverage from the ingredients contained in the first capsule and to provide a first beverage via said dispensing unit.

15. The capsule system according to claim 1, wherein:
said conveying carriage has an illumination region with a plurality of illumination states; and
said control unit is configured to activate said illumination region in order to output information relating to a production of the first beverage by way of the plurality of illumination states.

16. The capsule system according to claim 14, wherein the information relating to the production of the first beverage includes at least one information item selected from the group consisting of a process status during the production of the first beverage and a type of the first beverage being produced

17. The capsule system according to claim 14, wherein said conveying carriage has an interchangeable front section.

18. The capsule system according to claim 14, further comprising a protective bracket embodied to enclose said conveying carriage in the extended state.

19. The capsule system according to claim 14, further comprising
a pressure sensor configured to detect an external force acting on said conveying carriage in the extended state, which external force acts in a direction of the retracted state of the conveying carriage; and
wherein said control unit is configured to cause said conveying carriage to be moved into the retracted state in response to a detection of the external force.

20. The capsule system according to claim 14, further comprising a sensor configured to detect that the first capsule is transferred to the capsule system by way of said receiving unit; and
wherein, in response thereto, said control unit is configured to cause said conveyor to convey said first capsule to the processing position.

21. The capsule system according to claim 14, further comprising
a read sensor configured to capture information relating to a capsule received by the receiving unit; and
wherein said control unit is configured to produce the first beverage as a function of the captured information relating to the first capsule.

22. The capsule system according to claim 14, configured to produce a beverage from a capsule that comprises a plurality of chambers containing different substances for producing a beverage.

23. The capsule system according to claim 22, wherein:
the capsule comprises an outer shell which has an outer base, an outer side wall and an outer lid forming an overall cavity of the capsule;
the capsule comprises at least one inner shell inside the overall cavity of the capsule and forming a second chamber for receiving a second volume of a second ingredient; wherein a remaining cavity of the capsule is formed by the overall cavity minus the at least one inner shell is a first chamber for receiving a first volume of a first ingredient; and
said processing device is configured to open the inner shell of the capsule and to create a cavity within the capsule for receiving a mixture which fully comprises the first ingredient and the second ingredient.

24. The capsule system according to claim 23, wherein said processing device is configured to tilt the capsule in order to pour the mixture out of the capsule through an opening in the outer lid due to a force of gravity.

25. The capsule system according to claim 14, wherein said housing has a front wall and said receiving unit is arranged on said front wall of said housing.

26. The capsule system according to claim 25, wherein said receiving unit is embodied to enable a capsule having an upward-oriented lid to be introduced into said receiving unit.

27. The capsule system according to claim 14, further comprising a user interface enabling a user to cause said conveyor to convey a capsule to the processing position.
